(19) United States
(12) Patent Application Publication
(10) Pub. No.: US 2009/0265220 A1
(43) Pub. Date: Oct. 22, 2009

(54) INTELLIGENT MULTI-CHANNEL TARGETED TELECOMMUNICATIONS ADVERTISEMENT CAMPAIGN MANAGER

(75) Inventors: ISMAIL BAYRAKTAR, Istanbul (TR); Seyhan CIVANLAR, Palo Alto, CA (US); Erhan LOKMAN, Istanbul (TR); Oguz OKTAY, Apex, NC (US); Aziz SEVER, Ankara (TR)

Correspondence Address: IP Authority, LLC;Ramraj Soundararajan, 4821A Eisenhower Ave, Alexandria, VA, 22304, US

(73) Assignee: ARGELA TECHNOLOGIES, ISTANBUL (TR)

(21) Appl. No.: 12/413,957

(22) Filed: Mar. 30, 2009

Related U.S. Application Data
(63) Continuation of application No. 12/105,637, filed on Apr. 18, 2008.

(51) Int. Cl. G06Q 30/00; H04M 3/00; H04W 4/00

(52) U.S. Cl. 705/10; 705/14; 379/266.07; 455/466

(57) ABSTRACT

The present invention is a system and method to enable advertisement subsidized telecommunications services, which can deliver a campaign comprised of multiple advertisements, each advertisement using a different format (text, audio and video), to user's different terminals (cell phone, soft phone, PDA, PC, etc.) by using different telecommunications channels (text message, phone call, multimedia message, ring tone) simultaneously. The system is comprised of three layers: a campaign manager to manage campaign state, a service logic, which determines the user population and the channel best matching each advertisement's content and format, and a channel manager which emulates a confederation of service applications to simultaneously tap into various telecommunications channels through a Service Delivery Platform (SDP), or by directly attaching to the operator's network.

### RELATED APPLICATIONS

This application is a Continuation of U.S. application Ser. No. 12/105,637 filed Apr. 18, 2008, pending.

### BACKGROUND OF THE INVENTION

1. Field of Invention

The present invention relates to a system and method suitable for remote selection and real-time delivery of customized content such as advertisements, and insertion into a telecommunications session based on the session technology, user terminal characteristics, delivery channel capabilities, the sending and receiving side user profiles and preferences, and other campaign parameters. In particular, the present invention relates to a system and method used to enable subsidized telecommunications services through advertiser sponsorship model.

2. Discussion of Prior Art

Telecommunications operator's capabilities have evolved to offer many different types of services to its users leveraging the public switched telephony network (PSTN), network-based intelligence through systems known as Intelligent Networks (IN), IP protocol-based networks such as Public Internet, cellular, ADSL, cable, WiFi or broadband access networks, or a combination of all these different types of networks. With these evolutions, users are now able to subscribe to a single operator to make local and international calls, as well as sending and receiving text messages, sending and receiving email or multimedia messages. For example, the mobile operators are offering service packages that include voice services as well as short message service (SMS), multimedia service (MMS), Instant Messaging (IM), Push to Talk (PtoT) and Blackberry email services. Meanwhile, Voice over IP (VoIP) operators, who mainly use the public Internet to transport telecommunications services, offer a downloadable soft phone to their subscribers, designed for a Personal Computer (PC) or a handheld device, to make multimedia phone calls or send or receive text messages. They also support services such as ‘presence’, through which the user can see which of his/her contacts are currently available to receive services. Users can chat with one another with text messages using the instant messaging service.

With IN capabilities, the operators are able to offer different billing packages. For example, users can subscribe to prepaid or post-paid services. It is possible to offer service packages that are price subsidized through advertisement placement. Through the use of IN systems, the subscriber profiles and preferences are used in handling a telecommunications session such as providing customized ring-back-tone, playing special messages, applying different type of billing for each call depending on calling or called party preferences.

Telecommunications operators are offering converged services by bundling network, access and services capabilities and different billing methods under a unified service creation and delivery architecture using a software system called Service Delivery Platform (SDP). Using a SDP, the telecommunications service provider or third party service providers can rapidly deploy services using different telecommunications channels through use of IN, Internet and PSTN network capabilities. The SDP essentially conceals the complexity of a plethora of network protocols (such as SMMP, MM7, SIP, UCP, ISUP, INAP, MAP, DIAMETER, RADIUS, and many more) by providing an abstraction layer to use a network channel (such as SMS) and service capabilities (such as billing) to quickly create and deploy new services. One of the well-known SDP abstraction architectures is SOA (Service Oriented Architecture), which leverages J2EE and web technologies to create and deploy new services. Other competing abstraction architectures are JAIN, PARLAY and SIP.

Using a SDP, a third party can write a service application that uses a telecommunication channel. An example service application sends a daily weather report to cell phone users on a subscription basis. The subscription can also be done through sending an SMS to a specific service number. Another service application is an airline customer receiving a text message from an automated system regarding a flight cancellation or schedule change. Such services are usually not created by the mobile operator, but by third party service providers using simple SDP APIs to send messages to operator's subscribers and to bill them. Thereby, the third party service providers and the operator form an ecosystem.

While telecommunications services evolve, the competition between the telecommunications operators further intensified, creating a constant pressure to lower the price of service. Many operators offer free or almost free calling capabilities or bundled free SMS services just to retain their customer base. The telecommunications operators need a new revenue model to increase the Average Revenue Per User (ARPU). We believe advertisement-enabled-telecommunications is that new revenue model where the operator finds a new revenue stream through advertisers, while the users pay highly subsidized rates or receive completely free services if they accept advertisement insertion into their telecommunications service.

Advertising through telecommunication channels is a virgin area. It offers to advertisers a direct marketing possibility. Different than the common and traditional advertisement channels such as newspaper, TV, radio, billboards, and mail, telecommunication channels provide the added benefit of direct targeted marketing advantage as the end-user can be classified in age, gender, level of income, location, and education level. Sponsoring calls through advertisement will definitely open up a new and controlled channel for the advertisers. The network evolution enables the inserting of targeted advertisements to telecommunications channels using IN, SDP and IP technologies.

There are companies such as free411, Jajah®, Voodoovox® and Tuitalk® offering advertisement sponsored 411-directory services, and local and international calling services, respectively, for free. We believe that there will be many more such companies emerging in the future creating a need for a campaign manager which can tap into all communications channels.

Nowadays, the Internet is considered the most powerful media for advertising. In its simplest form, web advertisement is directly linked as fixed inline images into a web page. Advertisement campaign management systems of different complexity are being used to deliver targeted advertisements to web pages using flexible systems that allow a separation of advertisement selection and placement, but offer only a random selection mechanism. With these systems, each user who requests the page for display will potentially see a different inline image since the selection process is called for each user individually. Langheinrich describes a campaign manager in U.S. Pat. No. 6,654,725. This system intelligently delivers customized advertisements into web pages. Angles describes a system in U.S. Pat. No. 5,933,811 to deliver customized advertisements by using user profile information to select the advertisement to insert into a browser-based content. However, neither of these patents describes a system to deliver advertisements to multiple telecommunications channels and multiple terminal types across multiple operators.

Insertion of advertisement or a message during a traditional phone call is well known and documented in prior art. For example, Chavez et al. describes, in U.S. Pat. No. 6,603,844, a system in which an advertisement in the form of an audio message which is paid for by a third party is inserted during ring-back-tone in a telecommunication network. Insertion of advertisements into a VoIP stream is also prior art. For example, Olshansky describes, in U.S. Pat. No. 6,492,437, a system where a VoIP service provider plays an advertisement during a call to generate a bill based on a subsidized billing rate. However, there is no prior art, which shows how to simultaneously use multiple telecommunications channels over multiple terminal types for delivery of complex advertisement campaigns.

Charles M. Link, in U.S. Pat. No. 6,993,326, describes a targeted advertising system that transmits advertisement information using text messaging when a wireless device is located within a reasonable proximity to the advertiser. Although this patent describes location as a determinant for pushing text from targeted advertisements, it does not address user preferences and use of many telecommunications sessions and channels simultaneously.

Campaign management systems are vastly used for browser based advertising. Companies such as Doubleclick®, Google® and Yahoo® and many others have been deploying such campaign management systems solely to service browser-based advertising.

Whatever the precise merits, features, and advantages of the above cited references, none of them achieves or fulfills the purposes of the present invention.

### SUMMARY OF THE INVENTION

The use of advertisement in telecommunications channels and services create the need for a special type of advertisement campaign manager, which determines the advertisements based on channel type and terminal type, and delivers it to the channel using the suitable technology. The present invention provides for such a system and method.

An objective of the present invention is to provide a new way of delivering campaigns to telecommunications and online service users using the terminal properties and types of delivery channels without needing to use multiple campaign management systems, one for each type of technology and telecommunications service. Another objective of the present invention is improving the method for providing a highly customized advertisement selection and delivery on the network.

One objective of the invention is to seamlessly deliver advertisements to users while they use different telecommunications services. For example, the user may be making local phone calls, and sending and receiving SMS text messages over a cell phone, using a soft phone to make less expensive international calls and using an instant messaging software for instant messaging. All of these channels can be used for presentment of advertisement to the user. However, each channel is using a different technology and can't accommodate the same type, length and form of advertisement. The campaign management system must be smart enough to select the right form of advertisement for the user's channel. For example, the insertion of a short text-based advertisement or simply a URL in a text message is possible, while one can insert a video advertisement before a phone call if the user is using a soft-phone with multimedia capabilities. Similarly, the user can be sent an audio advertisement as a ring tone or during the ring back tone on a cell phone. The advertisement type, length and format have to be selected by the sponsor's campaign management system in real-time while the user is simultaneously using various services from the same service provider.

This objective can further be extended to include non-telecommunications online services (such as web browsing) over the public Internet in addition to the telecommunications services. As the boundary between telecommunications and online services continue to fade, the system can apply to both domains easily using web services as another ‘channel type’.

An aspect of this invention is ‘multi-channel control’ which enables ‘sequential’ targeting using different channels (i.e., after delivering a video message through the soft-phone, follow up with the same message via MMS or a simplified text version of the message with SMS to the same user.) Sequential targeting may create better awareness on the message.

There are third party service providers who are able to send advertisements to users of the telecommunications operator in the form of a text message using SMS, or email. For example, such third parties send advertisements of local merchants and banks to cell phone users using text messaging. These third parties may use simple campaign management systems, which enable a targeted advertisement selection based on user's profile (locality, age, etc.) if such a profile information can be obtained from the operator or another source, or may simply send a bulk-message to a group of users without any targeting. However, none of these third parties are able to use multiple channels and multiple formats of advertisement suitable for each channel in a manner to deliver targeted ads.

Another aspect of this invention is the ability to intelligently control the advertisements sent to the user. For example, an individual can be sent messages from a single advertiser at a time through multiple channels instead of being bombarded with irrelevant messages coming from many advertisers.

The present invention, hereinafter represented as OCTOPUS, describes a unique campaign manager, which delivers advertisements to multiple telecommunications operators and multiple advertisement service providers through various channels (SMS, MMS, call, email, IM, IVR, RSS, and IPTV) in multiple formats (text, audio, banner, image, video), through push, insert and pull techniques, and can apply multi-channel control functionality to deliver the same message simultaneously or sequentially to multiple channels.

The present invention provides for a method for developing a multi-channel targeted telecommunications advertisement campaign manager to deliver advertiser-sponsored telecommunications services to users, wherein the method comprises the steps of: (a) receiving a campaign comprising a plurality of advertisements, wherein the advertisements being in a plurality of different formats and the advertisements being associated with an advertisement profile, and the plurality of advertisements targeting a plurality of end-user communication devices; (b) identifying a subset of users in a telecommunications user population for delivery of the advertisements, each user in the population being associated with a user profile, the identification being done based on: comparing the advertisement profile with each user profile in the population to determine a matching subset of users that fit the advertisement profile; (c) for each user in the subset of users, identifying at least one telecommunication channel from a user's channel delivery preference, checking to determine if said user's channel delivery preference allows delivery of at least one format of advertisement, and activating the at least one telecommunications channel to deliver at least one format of advertisement.

The present invention also provides for a system comprising: (a) a campaign manager to manage a campaign comprising a plurality of advertisements, wherein the advertisements are in a plurality of different formats and the advertisements being associated with an advertisement profile, and the plurality of advertisements target a plurality of end-user communication devices; (b) a service logic to identify a subset of users in a telecommunications user population for delivery of the advertisements, each user in the population being associated with a user profile, and the identification being done based on: comparing the advertisement profile with each user profile in said population to determine a matching subset of users that fit the advertisement profile, and (c) a channel manager which, for each user in said subset of users, identifies and manages at least one telecommunication channel from a user's channel delivery preference, checks to determine if the user's channel delivery preference allows delivery of at least one format of advertisement, and activates the at least one telecommunications channel to deliver at least one format of advertisement.

### BRIEF DESCRIPTION OF THE DRAWINGS

FIG. 1 illustrates an exemplary description of the multi-channel targeted campaign manager connecting to different types of telecommunications operators and other type of Internet Content Providers.

FIG. 2 illustrates an exemplary implementation of a telecommunications network with an SDP.

FIG. 3 illustrates an exemplary high-level system component diagram of OCTOPUS.

FIG. 4 illustrates a method for OCTOPUS receiving a new campaign and determining the user population to execute the campaign.

FIG. 5 illustrates another method of OCTOPUS pushing a textual advertisement as an SMS.

FIG. 6 illustrates another method of OCTOPUS inserting a multimedia advertisement as a video into a ring tone client.

### DESCRIPTION OF THE PREFERRED EMBODIMENTS

While this invention is illustrated and described in a preferred embodiment, the invention may be produced in many different configurations. There is depicted in the drawings, and will herein be described in detail, a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

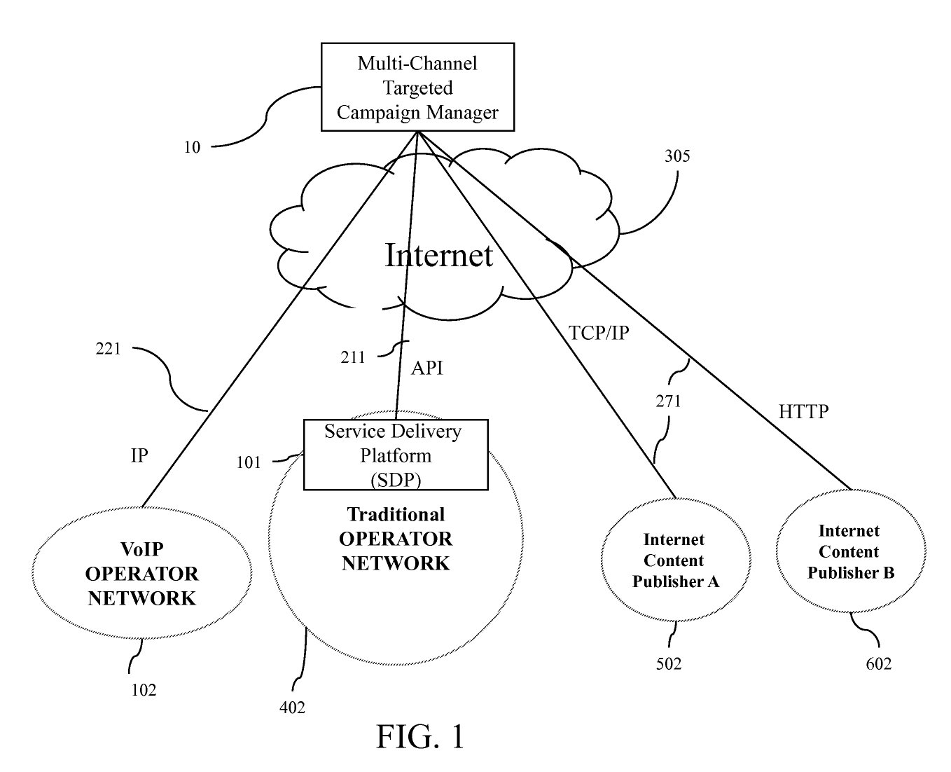

As described in the summary of invention above, OCTOPUS simultaneously serves one or more telecommunications operators, and one or more Internet Content Publishers (ICP). As such, OCTOPUS (Multi-Channel Targeted Campaign Manager) 10 of FIG. 1 connects to the Public Internet to simultaneously attach and serve multiple service providers. For example, VoIP operator 102 provides to its users voice services over IP. OCTOPUS attaches to this network via an IP based protocol such as SIP on interface 221. OCTOPUS can also attach to traditional operator 402 through SDP 101 using interface 211.

OCTOPUS attaches to providers ICP 502 and ICP 602 via TCP/IP protocols using interface 271. These providers provide special capabilities to easily identify the user's profile and preferences (for example using a registry procedure or by identifying the IP address of the user) to offer targeted advertisements over a non-telecommunications channel. It is much more complex and not so well understood to deliver advertisements to telecommunications channels (as opposed to web channels). The present invention focuses on communications with telecom operators and details the use case scenarios regarding delivery of advertisements in such a scenario. It would be trivial to extend the use case scenarios to web channels.

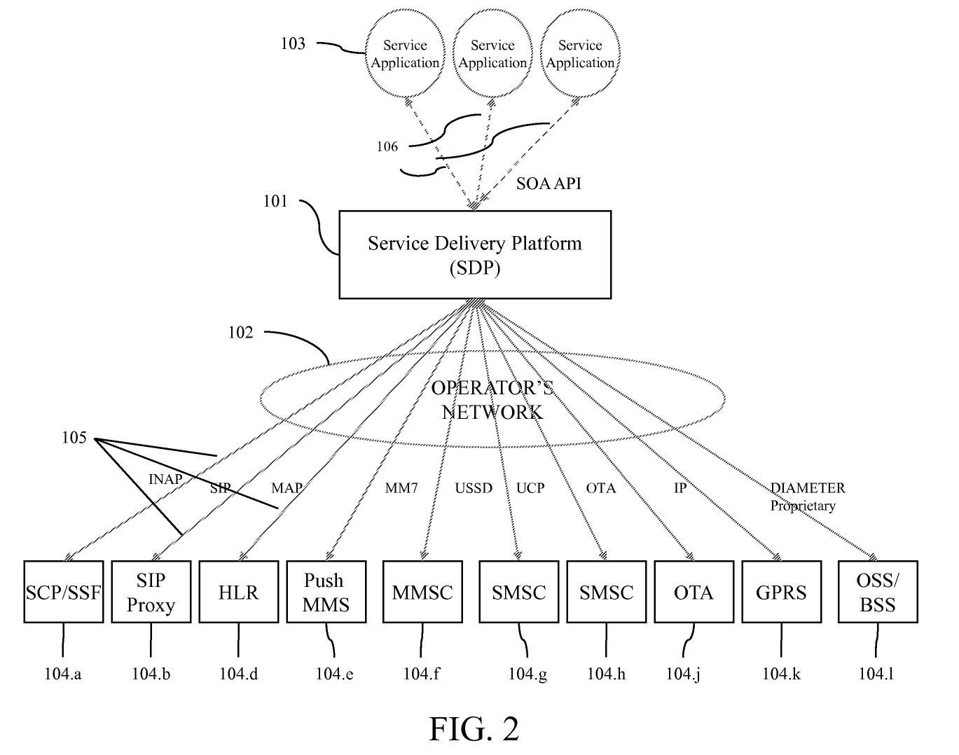

An SDP is an important connectivity point of OCTOPUS. As shown in FIG. 2, the SDP 101 attaches to an operator's telecommunications network 102 to provide access to many network service capabilities. One or more service applications 103 can be created and deployed using SDP 101 using SDP API 106 (such as provided by SOA). The service application 103 may co-reside with SDP 101 or can be remote.

The interface 105 of SDP 101 supports many network protocols to access different service capabilities. For example, SDP 101 may connect to Home Location Registrar (HLR) 104.d to retrieve location or profile information about the user. The interface 105 towards the HLR supports the Mobility Access Protocol (MAP). Similarly, SDP 101 may connect with interface 105 to Service Control Point (SCP)/Service Switching Function (SSF) 104.a with Intelligent Network Access Protocol (INAP). Through this interface, SDP 101 offers IN capabilities such as customized ring-back-tone service to remote applications. Many other possible protocols are shown in FIG. 1 for interface 105, each of which enable different capabilities, e.g., the connection to SMSC 104.g and 104.h provides capability to write a service application 103 to send and receive text messages using different text messaging protocols. Similarly, the connection to Operating Support Systems/Business Support Systems (OSS/BSS) 104.1 makes different billing and provisioning options possible.

OCTOPUS is a multi-channel sponsored-telecommunications service management software, which attaches to one or more operator networks and/or ICPs. It may alternatively co-reside within one telecommunications operator's network or in one ICP's network.

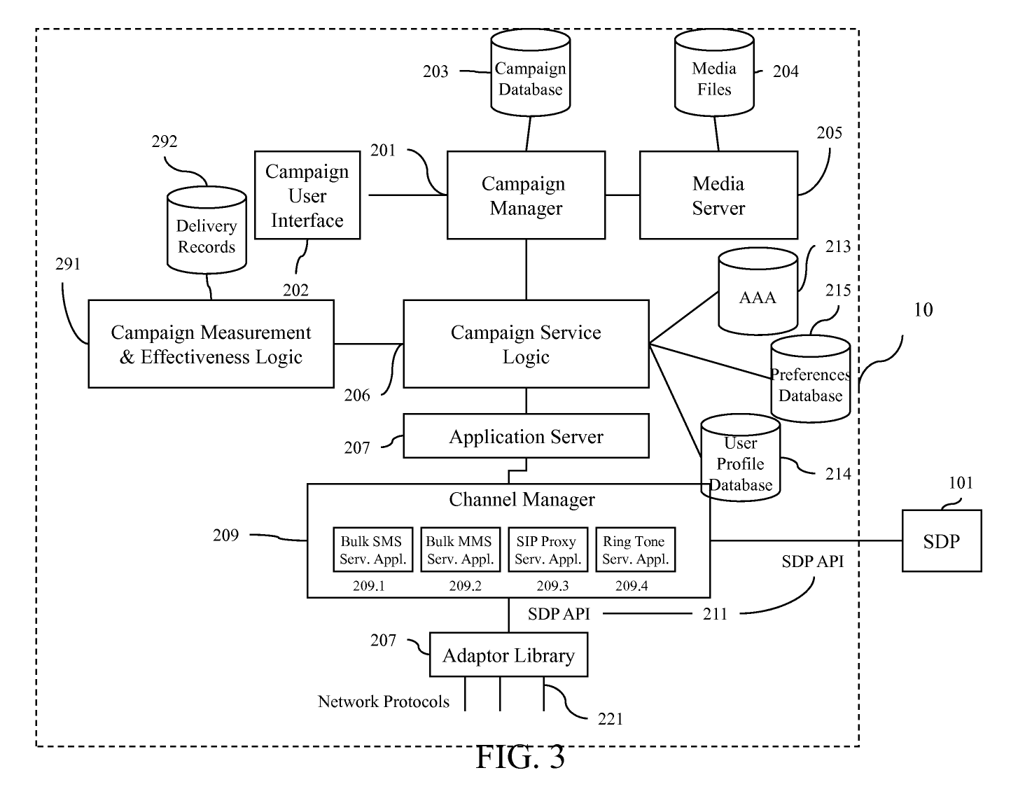

As shown in FIG. 3, the key components of OCTOPUS are:

Campaign Manager: Campaign Manager 201 enables advertisers to remotely enter and run their advertisement campaigns. The operator can approve or reject campaigns.

A campaign is comprised of various sub-components:
Advertisement content (audio, video, text). This content may be stored in the database of media server 205 in the form of media files 204, or in a content management system, both of which are known in prior art.
Campaign Information. This information relates to all parameters of a campaign and stored in Campaign Database 203. The information contains:
   A pointer to the media file to retrieve the associated media from the media server database.
   Advertisement type (pre-roll, banner, flash, reminder unit, etc.)
   Advertisement encoding format(s) and size(s)
   Campaign begin and end time
   Singularity time period, if any. (The time period that an individual is exposed only to this campaign through different channels.)
   Applicable user profile (optional)
   Applicable location (optional)
   Applicable VoIP operator (optional)
   Applicable telecommunications channel(s):
      Text message (SMS)
      Email
      Audio call
      VoIP call
      Multimedia message (MMS)
      Instant message
      IP TV (on phone)
      IVR
      RSS
      Web channel

A campaign may be in different states:

Draft: The advertiser enters a campaign, but it is not submitted for approval yet. This stage occurs when the campaign scenario is still in the works by the advertiser. The advertiser may be allowed to use up to a specific number of draft campaigns. An already completed campaign may circle back as a draft campaign at a later time for a replay.
Approved: An approved campaign is finalized by the advertiser and put into the approval queue to receive an approval to start running the campaign. The campaign can stay at the approved state until the begin time of the campaign.
Active: An approved campaign becomes active at the specified begin time and runs until the end time of campaign. During the active stage, the advertisement is delivered to the specified telecommunications channel(s).
Completed: An active campaign is completed at the End time. A completed campaign may be kept in the campaign repository to be re-used at a later time.

The campaign manager 201 has a Campaign User Interface 202, which allows the campaign managers to manage their campaign data. This interface can be web-based (portal) or a downloadable campaign management client.

User Data:

The user database contains information on the user community who subscribes to the sponsored-telecommunications service and hence willing to receive advertisements during a telecommunications session. The data has three components:
(a) Authentication-Authorization-Accounting (AAA) database 213, which contains information such as user-ids, telephone numbers and encrypted passwords to authorize and authenticate users receiving the service;
(b) User profile database 214, which contains user's profile (gender, age, education, interests etc.) as it pertains to receiving advertisements. Associated with each user, there may be information about the user's physical location (updated in real-time or near real time), and user's terminal capabilities. This database is used when selecting the best matching advertisement for the user;
(c) Preferences database 215, which contains each user's channel, terminal and service mode preferences to receive advertisements. For example, User-A may prefer to receive advertisements while using the soft-phone and before a call begins and not during work-hours, and may not want to disable all other forms of advertisement, except for advertisements received on cell phone. A simple logical semantics stored in Campaign Service Logic 206 for the user-A would be:

My PREFERENCE: Send Ad:(on soft-phone):(insert before call):(after
5 pm); & NEVER: Send Ad: (on cell-phone);

For another user, say user-B, the logic may be:

My PREFERENCE: Send Ad:(on cell-phone):(push text message):(10 am
to 5 pm); & NEVER: Send Ad: (insert before call);

Campaign service logic 206 not only retrieves user-profiles, but also complex user-preferences logic to send advertisements in the most effective and preferred mode.

Campaign Service Logic

Campaign Service Logic 206 is where the actual sponsoring decision is made, the user profiles and preferences, and campaign parameters are retrieved from proper repositories; the advertisement is inserted into the channel; and delivered to the network through Channel Manager 209. Campaign Service Logic 206 may be implemented in software with an Application Server 207. Such Application Servers are prior art and available commercially.

Campaign Service Logic (CSL) 206 has a three-step logic (there may be many other steps that are omitted here):

(I) CSL 206 first receives a ‘new’ campaign request from Campaign Manager 201 when a campaign becomes ‘active’. The campaign content (e.g., different forms of advertisement content) and campaign attributes are pushed to the service logic at that time.

(II) CSL 206 determines the user population who should be receiving the campaign of step (I). It makes a determination of list of users who will be candidates to receive the campaign as well as the channel type and terminal type. For example, if the new campaign entails only a text-form (SMS) advertisement for a particular type of ‘interest’, then all the users who are willing to accept ‘push SMS’ and fall into the ‘interest’ group are enlisted to receive the campaign. Another example is, if the new campaign entails a video-advertisement tailored for a ‘soft-phone’ type multimedia terminal and for a particular type of ‘interest’, then all the users who declared ‘soft phone’ as a preference, and fall into the ‘interest’ group are enlisted to receive the campaign.

Another parameter that CSL considers is number of campaigns active on a particular user. For example an active campaign may require that while it is active on a user other campaigns should not be delivered to that user. It is also possible that the number of campaigns active on a particular user can be restricted by the platform operator or “OCTOPUS's measurements and efficiency module” to maximize the effectiveness of active campaigns.

(III) The last step is to execute the campaign on the user population selected in step (II). This can be done in a variety of ways depending on channel type. For example, a ‘push SMS’ advertisement can be executed by the service logic creating the content of the SMS using the campaign's advertisement text and sending the following message to Channel Manager 209:

(channel-req.=push): (channel-type=SMS): (terminal-type=cell-phone)

The Channel Manager 209 will in turn activate the channel. If the usage of the channel is more complex (such as inserting an advertisement before a call begins on a soft phone), then the message, which will be sent to Channel Manager 209, will be:

(channel-req.=insert):(channel-type=call):(terminal-type=soft-phone)

In response, the Channel Manager 209 starts obtaining the call state information from the SIP Proxy 104.b about a specified list of users (specified in the user population group) who are registered on the soft-phone client so that the advertisement can be inserted to those users' calls.

The Service Logic also monitors the life cycle of the campaign from the start to the end of campaign and ensures appropriate statistics are collected and stored.

Campaign Measurement and Effectiveness Logic (CMEL)

Campaign Measurement and Effectiveness Logic 291 continuously tests the campaign efficiency and effectiveness by recording user delivery and un-delivery responses in Database 292 (e.g., the click rate in case of a pre-call video advertisement or advertisement review inserted through mobile device clients or SMS delivery messages).

CMEL 291 may alter campaign parameters to maximize the effectiveness of a campaign. For example, CMEL 291 may discover that a user has more than a specified threshold of undelivered SMS messages with advertisement content, but has recently been receiving video messages through a soft phone on user's PC or handheld. This situation may occur if the user is out of the cellular coverage area (or cell phone turned off). CMEL 291 may decide to remove this user from the list of active SMS based campaigns and does not allow new campaigns to include this user for the text messages until it receives a delivery record of a previously sent SMS advertisement. It is known in prior art that SMSC, the SMS routing component of the network, stores all undelivered SMS messages and retries to delivery them at a later time. Once Channel Manager 209 forwards a delivery record of a particular advertisement enabled SMS previously sent down by Service Logic 206, this delivery record will be forwarded to CMEL 291. CMEL 291 stores the delivery record in database 292 and sends a ‘re-optimize message’ to Service Logic 206 so that SMS advertisements are now allowed in active campaigns. CMEL 291 sends such optimization messages to Campaign Service Logic 206 so that the user is delivered campaigns in more optimal channels.

Channel Manager

Channel Manager is the actual attachment point of OCTOPUS software to the physical network of the operator from one or more point of presence (POP). The Channel Manager may access the network channels by directly calling the abstraction APIs through the operator's SDP 101 (i.e., using SOA). Doing so, it can request an SMS, MMS, or IM service or request a specific form of billing for the channel using simple SOA/HTTP requests.

Channel Manager 209 can be modeled as a confederation of many different types of service applications each of which use a different telecommunications channel by making different API calls on interface 211 of SDP 101 (or alternatively, by connecting to the operator's network using different types of network protocols on interface 221 via Adaptor Library 207). In one instantiation of the Channel Manager, it may be viewed as a confederation of five different applications:
(1) Sending bulk SMS targeted to many cell phones (using bulk SMS APIs);
(2) Sending bulk MMS targeted to many cell phones (using bulk MMS APIs);
(3) Inserting text to an existing SMS destined to a cell phone (using SMS APIs);
(4) Inserting video at the beginning of a phone call destined to a soft phone (using SIP Proxy APIs).
(5) Pushing ring tone to a ring tone client (using ring tone APIs)

Adapter Library 207, shown in FIG. 1, is provided with Channel Manager 209 so that OCTOPUS software can connect to networks that do not have an SDP.

Channel Manager 209 performs the act of advertisement ‘insertion’ when the user initiates a session with another user. For this purpose, it gets into a ‘session observing’ state. On the other hand, it can also perform the advertisement ‘pushing’ act completely autonomously. No state information is required about the user sessions.

### Use Case Scenario:

In order to depict OCTOPUS' simultaneous use of different telecommunications channels on multiple terminal types as part of a single advertisement campaign, we selected three different formats of advertisements (text, audio and multimedia) as part of an exemplary campaign (say a car manufacturer's campaign). Each format of advertisement forms a ‘sub-campaign’ within the campaign as the matching profiles and preferences of the user population may be different from another sub-campaign within the same campaign. We compose a campaign and matching user population from its parts as follows:

Campaign = {Sub-campaign 1 (media type 1) & Sub-campaign 2
(media type 2) & ...& Sub-campaign n (media type n)}
User Population = {User Population 1(Sub-campaign 1) & User
Population 2(Sub-campaign 2) & ...& User Population n(Sub-campaign n)}

As part of the exemplary campaign, the three types of media are sent to users using various channels, as follows:
1. Media type 1 (text): this media type will be sent to users in the form of a bulk-SMS. Meaning, the content of the advertisement will become a text message, which will be pushed to all users with matching profile by sending an SMS to their cell phones. This sub-campaign is characterized by:

Sub-campaign 1 (media type 1) = {Channel-type=SMS: Operation=Push
bulk-SMS: Terminal-type=Cell Phone}

2. Media type 2 (audio): this media type will be pushed to users as a ring tone. The ring tone client resident on the cell phone selects a ring to play when the user's phone rings. The advertisement will be pushed to the user's cell phone to play when it rings. This sub-campaign is characterized by:

Sub-campaign 2 (media type 2) = {Channel-type=Ring Tone:
Operation=Push Ring Tone: Terminal-type= Ring Tone client}

3. Media type 3 (multimedia): this media type will be inserted to VoIP calls during ringing and will also be pushed as an MMS message. Meaning, when the user initiates a call, a short advertisement will play first and then the call will continue. This can be achieved during a VoIP call using a soft phone with multimedia capabilities. This sub-campaign is characterized by:

Sub-campaign 3 (media type 3) = {Channel-type=Call:
Operations=Ad-insert: Terminal-type=Soft Phone}

The MMS sending and receiving capability is supported on cell phones. Therefore, the multimedia message will be pushed to cell phones in the form of bulk MMS. This sub-campaign is characterized by:

Channel-type= MMS: Operations=Push bulk MMS: Terminal-type=Cell
phone

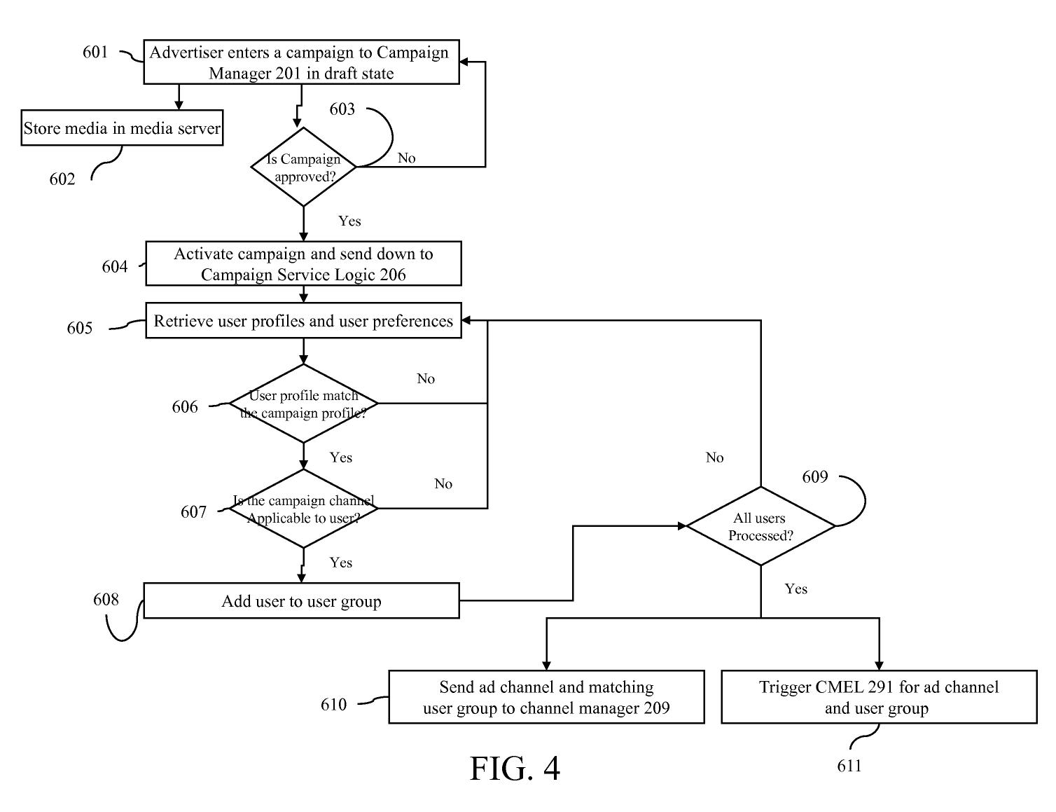

First, as shown in FIG. 4, the campaign described above is entered into Campaign Manager 201 in step 601. The three different types of advertisement media (text, audio and multimedia) are stored in the database of the media server in step 602. In step 603, the Campaign Manager 201 checks to determine if the campaign is approved. If yes, in step 604, the campaign is activated and sent down the Campaign Service Logic 206 for execution. In step 605, the Campaign Service Logic 206 retrieves the applicable user profile and starts a user population matching process. First, it checks to determine if the user's profile matches the specified first sub-campaign profile in step 606. If the answer is yes, then in step 607, it checks to determine if the user allows advertisement delivery on the channel specified in that sub-campaign. This is performed using the user preferences. If the user is selected for the campaign, then he/she is added to the user population in step 608.

The user populations for various sub-campaign categories may be different. Therefore, the user population determination must be made on a per sub-campaign basis. Once the campaign user population (with all associated sub-campaign user populations) is determined, the service logic triggers the CMEL 291 for efficiency optimization and delivery record collection. In parallel, it sends the user group, channel type and media information to Channel Manager 209 in step 610 to start delivering the campaign.

Channel Manager 209 plays the role of multiple service applications towards SDP 101 so as to tap into many different channels in parallel. Meaning, it simultaneously emulates many service applications, e.g., one application sending a bulk SMS, another application sending a bulk—MMS or yet another one intercepting call processing. All these functions essentially emulate the channel application services that are within the Channel Manager.

Delivery of Advertisement to SMS Channel:

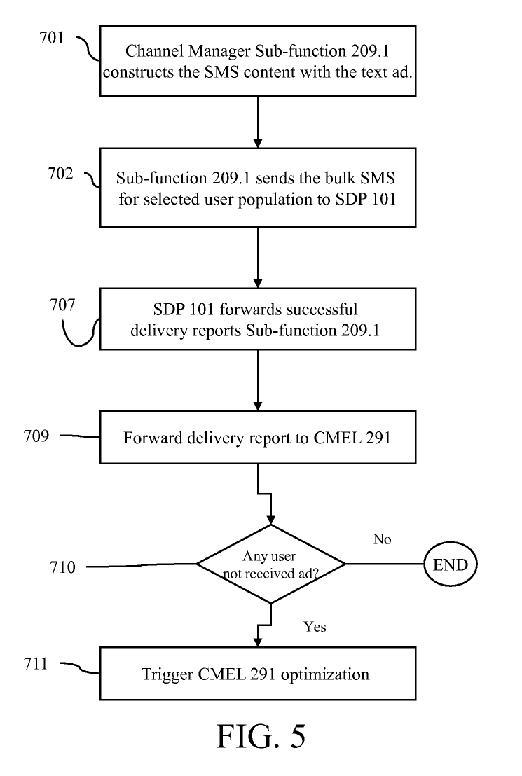

As illustrated in FIG. 5, once Channel Manager 209 receives the bulk-SMS sub-campaign associated with the user group, it sends the request to its Bulk SMS service application sub-function 209.1 shown in FIG. 3, which first constructs the SMS message in step 701, and sends a bulk-SMS request with the user population of Sub-campaign 1 in step 702 towards SDP 101 using SDP API 211.

Once Bulk SMS is pushed to the cell phones of user population, the SDP sends back to Channel Manager 209.1 a report of successful delivery for those cell phones who received the SMS, which is then forwarded to Service Logic 206 and then to CMEL 291 in steps 707 and 709, respectively.

CMEL's database 292 stores the delivery reports. In step 710, a successful delivery report for a user has not arrived even after the downstream SMSC retry period expires. In this scenario, CMEL 291 may trigger optimizations, such as removal of that user's cell phone number for advertisement-SMS delivery in step 711 until a preset time expires or a successful advertisement-SMS delivery report has been received for that phone number. Such optimizations can vary depending on implementation of CMEL 291.

### Delivery of Advertisement to MMS Channel:

The delivery of a sub-campaign using the MMS channel in the form of a bulk MMS operation is substantially similar to that of advertisement delivery on an SMS channel shown in FIG. 5, except (I) the format of the ad, and (II) the use of Channel Manager sub-function of 209.2 as opposed to 209.1. Note that Sub-function 209.2 uses the MMS APIs of SPD 101. This scenario is a trivial extension of the previously described scenario and hence not detailed here.

### Delivery of In-Call Advertisement to Call Channel

The delivery of a sub-campaign using the call channel is one of the most complex forms of advertisement delivery into a telecommunications channel. An advertisement can be delivered into traditional PSTN call channels in an audio format at the beginning of a call (e.g., during ring back tone) using intelligent networks (IN) capabilities. These IN capabilities must be exposed through SDP 101 to know the call state transition, or must be available through a direct INAP protocol hand-off.

Alternatively, an advertisement can be delivered to VoIP soft phone (also known as SIP phone) in a multimedia format at the beginning of a call (video, audio and image) or during a call (only video or image with muted audio). Sub-function 209.3 of Channel Manager 209 provides a standard SIP Proxy function to receive call signaling from the downstream SIP Proxy 104.b of FIG. 2 through SDP 101.

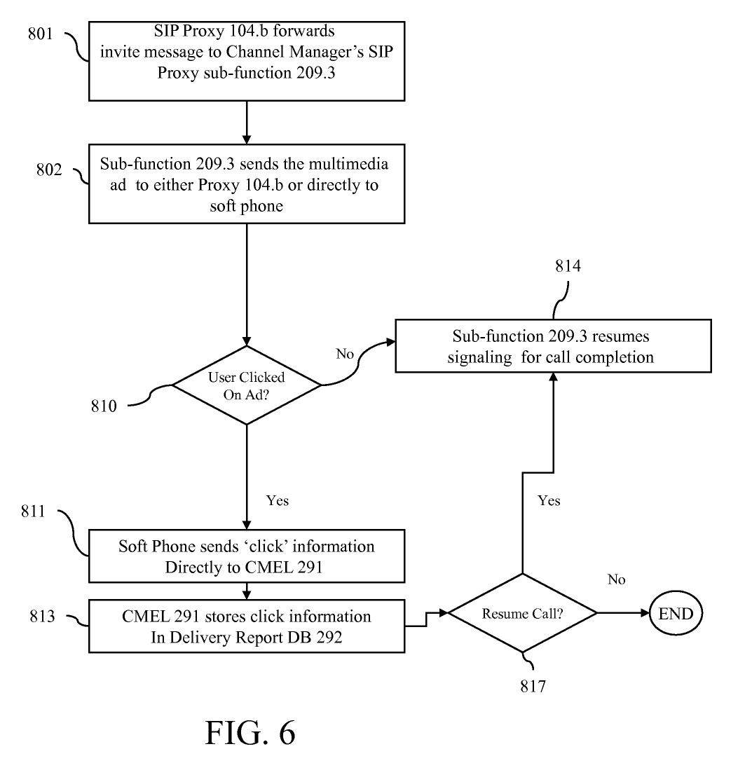

When a user initiates a VoIP call, the call signaling will be forwarded from soft phone to SIP Proxy 104.b of FIG. 2, which in turn will automatically forward the signaling messages in step 801 of FIG. 6 to SIP Proxy 209.3 through SDP 101 as the next-hop proxy. The IP address or name of the host that is the next-hop proxy is configured (as 209.3) into SIP Proxy 104 for the user population subscribed to in-call advertisement subsidized service.

Once an SIP ‘invite’ message is received by 209.3, it sends down the advertisement during signaling in step 802. The user may click on the advertisement before the call begins in which case a new web page or advertisement may pop up. If there is such a click action, the call signaling must either wait to resume (or completely stop the calling process) depending on what the user wants to do next. Step 810 checks to determine if there is a click action. If there is no clicking on soft phone, the call signaling is resumed at step 814 by sub-function 109.3 after which the called party's phone rings. If there has been a click action, then in steps 811 and 813 the click count record is forwarded to CMEL 291 and stored in database 292, respectively. The detection of click, and call completion steps highly depend on the soft phone functionalities as well as the campaign capabilities.

The use of signaling steps in delivering an advertisement using protocols such as RTP or HTTP is prior art. Although the in-call advertisement delivery is described using SIP protocol other VOIP protocols may easily be used in a similar manner.

Additionally, the present invention provides for an article of manufacture comprising computer readable program code contained within implementing one or more modules to implement an intelligent multi-channel targeted telecommunications advertisement campaign manager. Furthermore, the present invention includes a computer program code-based product, which is a storage medium having program code stored therein which can be used to instruct a computer to perform any of the methods associated with the present invention. The computer storage medium includes any of, but is not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, or any other appropriate static or dynamic memory or data storage devices.

Implemented in computer program code based products are software modules having: (a) computer readable program code working with a computer to receive a campaign comprising a plurality of advertisements, wherein the advertisements being in a plurality of different formats and the advertisements being associated with an advertisement profile, and the plurality of advertisements targeting a plurality of end-user communication devices; (b) computer readable program code identifying a subset of users in a telecommunications user population for delivery of the advertisements, each user in the population being associated with a user profile, the identification being done based on: comparing the advertisement profile with each user profile in the population to determine a matching subset of users that fit the advertisement profile; (c) for each user in the subset of users, computer readable program code identifying at least one telecommunication channel from a user's channel delivery preference, checking to determine if said user's channel delivery preference allows delivery of at least one format of advertisement, and activating the at least one telecommunications channel to deliver at least one format of advertisement.

### CONCLUSION

A system and method has been shown in the above embodiments for the effective implementation of an intelligent multi-channel targeted telecommunications advertisement campaign manager. While various preferred embodiments have been shown and described, it will be understood that there is no intent to limit the invention by such disclosure, but rather, it is intended to cover all modifications falling within the spirit and scope of the invention, as defined in the appended claims. For example, the present invention should not be limited by software/program, computing environment, or specific computing hardware.

The above enhancements are implemented in various computing environments. For example, the present invention may be implemented on a conventional IBM PC or equivalent, multi-nodal system (e.g., LAN) or networking system (e.g., Internet, WWW, wireless web). All programming and data related thereto are stored in computer memory, static or dynamic, and may be retrieved by the user in any of: conventional computer storage, display (i.e., CRT) and/or hardcopy (i.e., printed) formats. The programming of the present invention may be implemented by one of skill in the art of communications.

1. A method for developing a multi-channel targeted telecommunications advertisement campaign manager to deliver advertiser-sponsored telecommunications services to users, said method comprising the steps of:
receiving a campaign comprising a plurality of advertisements, said advertisements being in a plurality of different formats and said advertisements associated with an advertisement profile, said plurality of advertisements targeting a plurality of end-user telecommunication channels and communication devices over a plurality of telecommunication network operators' networks or service providers' networks;
identifying a subset of users in a telecommunications user population for delivery of said advertisements, each user in said population being associated with a user profile, said identification being done based on: comparing said advertisement profile with each user profile in said population to determine a matching subset of users that fit said advertisement profile;
for each user in said subset of users:
identifying a plurality of different telecommunication channels from a user's channel delivery preference;
checking to determine if said user's channel delivery preference supports delivery of at least one format of advertisement;
activating said plurality of different telecommunications channels; and
sequentially delivering at least one supported format of advertisement over said plurality of different telecommunication channels using service delivery platform (SDP) APIs, said SDP APIs aiding in delivering advertisement content as part of telecommunications content.

2. The method of claim 1, wherein said telecommunication channel supports any of the following: SMS messaging, MMS messaging, ring tone transmission, POTS-based phone calls, instant messaging, or voice mail communication.

3. The method of claim 1, wherein said advertisement content is in any of the following forms: SMS message, MMS message, an audio message at the beginning of the call, an audio message during a call, an video message at the beginning of the call, or an video message during a call.

4. The method of claim 1, wherein said format is any of, or a combination of, the following: text, audio, and video.

5. The method of claim 1, wherein said end-user communication device is any of the following: an IP-based phone, a software-based telephone, a POTS telephone, a cellular telephone, a personal computer (PC), a laptop, or a personal digital assistant (PDA).

6. The method of claim 1, wherein said activation of telecommunications channel involves attaching to a telecommunications operators network using network protocols emulating a service application.

7. The method of claim 1, wherein said activation of telecommunications channel involves attaching to a telecommunications operators network by emulating a SIP proxy.

8. A system comprising:
a. a campaign manager to manage a campaign comprising a plurality of advertisements, said advertisements being in a plurality of different formats and said advertisements associated with an advertisement profile, said plurality of advertisements targeting a plurality of end-user telecommunication channels and communication devices over a plurality of telecommunication network operators' networks or service providers' networks;
b. a service logic to identify a subset of users in a telecommunications user population for delivery of said advertisements, each user in said population being associated with a user profile, said identification being done based on: comparing said advertisement profile with each user profile in said population to determine a matching subset of users that fit said advertisement profile, and
c. a channel manager which, for each user in said subset of users:
identifies a plurality of different telecommunication channels from a user's channel delivery preference;
checks to determine if said user's channel delivery preference supports delivery of at least one format of advertisement;
activates said plurality of different telecommunications channels;
sequentially delivers at least one format of advertisement over said plurality of different telecommunications channels using service delivery platform (SDP) APIs, said SDP APIs aiding in delivering advertisement as part of telecommunication content.

9. The system of claim 8, wherein said telecommunication channel is any of the following: SMS messaging, MMS messaging, ring tone transmission, POTS-based phone calls, instant messaging, or voice mail communication.

10. The system of claim 8, wherein said format is any of, or a combination of, the following: text, audio, and video.

11. The system of claim 8, wherein said end-user communication device is any of the following: an IP-based phone, a software-based telephone, a POTS telephone, a cellular telephone, a personal computer (PC), a laptop, or a personal digital assistant (PDA).

12. The method of claim 1, wherein said activation of telecommunications channel involves attaching to a telecommunications operators network using network protocols emulating a service application.

13. The method of claim 1, wherein said activation of telecommunications channel involves attaching to a telecommunications operators network by emulating a SIP proxy.

14. The system of claim 8, wherein said advertisement content is in any of the following forms: SMS message, MMS message, an audio message at the beginning of the call, an audio message during a call, an video message at the beginning of the call, or an video message during a call.

15. A method for developing a multi-channel targeted telecommunications advertisement campaign manager to deliver advertiser-sponsored telecommunications services to users, said method comprising the steps of:
receiving a campaign comprising a plurality of advertisements, said advertisements being in a plurality of different formats and said advertisements associated with an advertisement profile, said plurality of advertisements targeting a plurality of end-user telecommunication channels and communication devices over a plurality of telecommunication network operators' networks or service providers' networks;
identifying a subset of users in a telecommunications user population for delivery of said advertisements, each user in said population being associated with a user profile, said identification being done based on: comparing said advertisement profile with each user profile in said population to determine a matching subset of users that fit said advertisement profile;
for each user in said subset of users:
identifying a first telecommunication channel and a second telecommunication channel from a user's channel delivery preference, said first telecommunication channel different from said second telecommunication channel;
checking to determine if said user's channel delivery preference supports delivery of a first advertisement format in said first communication channel and delivery of a second advertisement format in said second communication channel, and if so: (i) activating said first telecommunications channel and delivering a given advertisement in said first advertisement format over said activated first telecommunication channel, and (ii) activating said second telecommunication channel and delivering the given advertisement in said second advertisement format over said activated second telecommunication channel;
wherein sequentially delivery of second advertisement format after delivery of said first advertisement format is done using service delivery platform (SDP) APIs, said SDP APIs aiding in delivering advertisement content as part of telecommunications content.
